(19) United States
(12) Patent Application Publication
(10) Pub. No.: US 2023/0265279 A1
(43) Pub. Date: Aug. 24, 2023

(54) Color Stable Epoxy Compositions

(71) Applicant: 3M INNOVATIVE PROPERTIES COMPANY, St. Paul, MN (US)

(72) Inventors: Eric G. Larson, Lake Elmo, MN (US); Timothy D. Fletcher, Lino Lakes, MN (US); Scott B. Charles, Spring Valey, WI (US); Lisa Tann Erlandson McCarthy, White Bear Lake, MN (US)

(21) Appl. No.: 18/043,667

(22) PCT Filed: Sep. 9, 2021
(86) PCT No.: PCT/IB2021/058176

§ 371 Date: Mar. 1, 2023

Related U.S. Application Data
(60) Provisional application No. 62/706,810, filed on Sep. 11, 2020.

(51) Int. Cl. C08L 63/00; C08K 5/092

(52) U.S. Cl. CPC C08L 63/00; C08K 5/092

(57) ABSTRACT

A curable composition includes a non-aromatic epoxy resin; a non-aromatic curing agent; and a colorant. The cured composition that is the reaction product of the curable composition exhibits a non-overlap shear value on etched aluminum of at least 30 MPa.

### FIELD OF THE DISCLOSURE

The present disclosure relates to color stable epoxy compositions and articles containing such compositions.

### DETAILED DESCRIPTION

### Background

Epoxy based materials are known to have high adhesion and good durability for bonding to materials such as metals, glass, ceramics, and plastics. Due to these properties, they are widely used in bonding and assembly of electronic devices. However, conventional epoxy-based materials are not color stable—they yellow and/or darken significantly when exposed to heat, UV light, or household chemicals. This instability limits their application for adhesive bonding applications that are at least partially cosmetic, for example, in a visible location on the external portion of an electronic device. Consequently, color stable epoxy-based adhesives are desirable for certain cosmetic applications.

Often times, electronic devices (or electronic device components) are subjected to further processing steps after an adhesive is applied to the electronic device (or electronic device component). For example, certain aluminum electronic device components can be subjected to a chemical anodization process or dye infusion process at later stages of a device build. Both of these processes involve the use of harsh chemical treatments. Conventional epoxy-based materials darken dramatically under these conditions and therefore are not suitable for cosmetic applications. Consequently, in addition to excellent adhesion and color stability in the presence of heat, UV light, or household chemicals, for some applications, epoxy materials that are also color stable even when exposed to chemical anodization or dye infusion processes are desirable. Generally, the present disclosure is directed to the discovery of such epoxy materials.

Unless otherwise indicated, all numbers expressing feature sizes, amounts, and physical properties used in the specification and claims are to be understood as being modified in all instances by the term “about.” Accordingly, unless indicated to the contrary, the numbers set forth are approximations that can vary depending upon the desired properties using the teachings disclosed herein.

The terms “a”, “an”, and “the” are used interchangeably with “at least one” to mean one or more of the elements being described.

The term “adhesive” as used herein refers to polymeric compositions useful to adhere together two adherends.

The term “thermoset” refers to those materials that irreversibly cure to form a hard or rigid material.

The terms “Tg” and “glass transition temperature” are used interchangeably and refer to the glass transition temperature of a cured composition. Typically, unless otherwise specified, the glass transition temperature is measured by DSC (Differential Scanning Calorimetry) using well understood techniques.

The terms “room temperature” and “ambient temperature” are used interchangeably to mean temperatures in the range of 20° C. to 25° C.

The terms “aliphatic” and “cycloaliphatic” as used herein refer to compounds with hydrocarbon groups that are alkyl or alkylene groups.

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The term “alkylene” refers to a divalent group that is a radical of an alkane. The alkylene can be straight-chained, branched, cyclic, or combinations thereof. The alkylene often has 1 to 20 carbon atoms. In some embodiments, the alkylene contains 1 to 18, 1 to 12, 1 to 10, 1 to 8, 1 to 6, or 1 to 4 carbon atoms. The radical centers of the alkylene can be on the same carbon atom (i.e., an alkylidene) or on different carbon atoms.

The term “aromatic” as used herein refers to compounds with hydrocarbon groups that are aryl or arylene groups.

The term “non-aromatic” as used herein refers to compounds that do not include aryl or arylene groups.

The term “aryl” refers to a monovalent group that is aromatic and carbocyclic. The aryl can have one to five rings that are connected to or fused to the aromatic ring. The other ring structures can be aromatic, non-aromatic, or combinations thereof. Examples of aryl groups include, but are not limited to, phenyl, biphenyl, terphenyl, anthryl, naphthyl, acenaphthyl, anthraquinonyl, phenanthryl, anthracenyl, pyrenyl, perylenyl, and fluorenyl.

The term “arylene” refers to a divalent group that is carbocyclic and aromatic. The group has one to five rings that are connected, fused, or combinations thereof. The other rings can be aromatic, non-aromatic, or combinations thereof. In some embodiments, the arylene group has up to 5 rings, up to 4 rings, up to 3 rings, up to 2 rings, or one aromatic ring. For example, the arylene group can be phenylene.

The term “cured composition” refers to the reaction product of the curable composition.

The terms “curing time” and “time to cure” are used interchangeably and refer to the time required for a curable composition to cure. The term “cure” refers to the polymerization of reactive compounds. When referring to epoxy compositions, curing typically involves crosslinking, but the term curing does not necessarily refer to crosslinking. The curing time can be measured in a variety of ways. In some embodiments, curing time is measured using DSC (Differential Scanning Calorimetry), where curing time is determined as the time necessary to reach the maximum exotherm temperature. Other methods can also be used to determine curing time for two-part compositions, such as by continuous stirring with a stick, spoon, or blade until the mixture can longer be stirred.

In some embodiments, the present disclosure is directed to curable compositions that include a non-aromatic epoxy resin, a curing agent, a colorant, and optionally, an accelerator. The curable composition may also comprise an array of optional additives. Generally, the curable compositions, upon curing, having strong adhesive properties and are color stable even upon exposure to harsh conditions (e.g., chemicals exposure, heat exposure, UV aging).

In some embodiments, the curable composition may include at least one non-aromatic epoxy resin. Suitable non-aromatic epoxy resins include diglycidyl ether based epoxy resins and alicyclic epoxy resins such as diepoxy acetals, diepoxy adipates, diepoxy carboxylates, and dicyclopentadiene-based epoxy resins; isocyanurate derivative epoxy resins such as triglycidyl isocyanurate; and hydrogenated epoxy resins prepared by hydrogenating the aromatic ring(s) within aromatic epoxy resins such as bisphenol A epoxy resins, bisphenol F epoxy resins, phenol novolak epoxy resins, cresol novolak epoxy resins, naphthalene epoxy resins, biphenyl epoxy resins, aralkyl epoxy resins and biphenylaralkyl epoxy resins. Two or more of these resins may also be used in combination.

In some embodiments, the non-aromatic epoxy resins may be no color or low color and/or transparent resins. In this manner, the color of the curable compositions of the present disclosure may be established by the colorants included in the compositions.

In some embodiments, the non-aromatic epoxy resin is a liquid epoxy resin at room temperature. In some embodiments, the non-aromatic aromatic epoxy resin is the majority reactive component of the curable composition. In some embodiments, the curable composition comprises 50-95 or 60-90 parts by weight of non-aromatic epoxy resin per 100 parts total weight of reactive components.

In some embodiments, the curable composition also comprises one or more anhydride-based curing agents. As used herein, an “anhydride-based curing agent” refers to a compound formed by dehydrating a dicarboxylic acid according to structural formula (I), where A is an aliphatic or cycloaliphatic linking group.

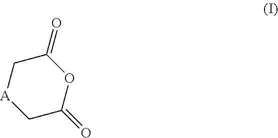

Examples of suitable anhydride-based curing agents include: linear polymeric anhydrides such as polysebacic and polyazelaic anhydride; alicyclic anhydrides such as methyltetrahydrophthalic anhydride, tetrahydro phthalic anhydride, methyl nadic anhydride, hexahydrophthalic anhydride, and methylhexahydrophthalic anhydride; simple alicylic anhydrides such as succinic anhydride, substituted succinic anhydride, citric acid anhydride, maleic anhydride and special adducts of maleic anhydride, dodecyl succinic anhydride, maleic anhydride, or multi-ring alicyclic anhydrides.

In some embodiments, the curable compositions comprise 10-45, 10-30, or 12-25 parts by weight of anhydride-based curing agent per 100 parts total weight of reactive components. In some embodiments, the curing agent consist of, or consists essentially of, anhydride-based curing agents.

In some embodiments, alternatively, the curing agents may include one or more amine-based curing agents. In some embodiments, the amine-based curing agents may be non-aromatic. Examples of suitable amine-based curing agents include: liquid polyetheramines such as the commercially available JEFFAMINE T-403 and JEFFAMINE D-230 from Huntsman Corp.; 4,7,10-Trioxatridecane-1,13-diamine, and 4,9-Dioxadodecane-1,12-diamine; polyamidoamines such as VERSAMID 125 and GENAMID 490 commercially available from BASF; ethyleneamines such as DETA (diethylene triamine), TETA (triethylenetetramine), TEPA (tetraethylenepentamine), and AEP (N-aminoethylpiperazine); cycloaliphatics such as PACM (bis-(p-aminocyclohexyl)methane), DACH (diaminocyclohexane), and DMCH (bis-(dimethyldi-aminocyclohexyl)methane); isophorone diamine, and norbornene dimethylamine.

In some embodiments, the curing agents may include no color or low color and/or transparent curing agents. In this manner, the color of the curable compositions of the present disclosure may be established by the addition of one or more colorants to the compositions.

In some embodiments, the curing agent is a liquid at room temperature.

In some embodiments, the curable compositions comprise 10-35, 10-20, or 12-18 parts by weight of amine-based curing agent per 100 parts total weight of reactive components.

In some embodiments, the curable compositions of the present disclosure may include one more colorants (or dyes or pigments). As used herein, the term “colorants” refers to a substance that is added to the composition for purposes of imparting color and/or other opacity to the compositions—the term “colorant” does not encompass the reactive components or any other materials added to the curable compositions to effect cure. For example, one or more colorants may be present in the curable composition such that the cured curable composition “color matches” the color of a component to which the cured composition will be adjacent (e.g., an external/user visible component of an electronic device). Various types of colorants may be suitable for the curable compositions including commercially available dyes for the azo (e.g, Oil Red O) and anthraquinone (e.g., Solvent Blue 35) family of colorants. In some embodiments, suitable colorants may include organic dyes such as azo, anthraquinoe, phthalocyanine blue and green, quinacridone, dioxazine, isoindolinone, or vat dyes. In some embodiments, the colorants include copper phthalocyanine (blue and green), azo, diarylide, quidacridone, isoindoline, diketo-pyrrole, indanthrone, carbon blacks, iron oxides, or titanium dioxides.

In some embodiments, the colorant may be dispersed or otherwise disposed in the curable compositions (as well as the cured compositions) such that the compositions have a uniform or substantially uniform color throughout their composition at a wide range of operating temperatures (e.g., between −40 and 85 degrees Celsius). In some embodiments, the colorant may be stable in the curable compositions (i.e., (i) non-reactive or substantially non-reactive with or not consumed by the components of the curable composition; and (ii) remain uniformly or substantially uniformly dispersed or otherwise disposed, in the working fluid at a wide range of operating temperatures over extended periods).

In some embodiments, colorants may be present in the curable compositions in an amount of between 0.1 and 10 wt. % or between 0.1 and 5 wt. %, based on the total weight of the reactive components.

In some embodiments, the curable composition may also include one or more accelerators. Generally, the accelerators may speed up the reaction time at room temperature for the curing of the curable composition. Moreover, the curable compositions of the present disclosure may employ accelerators that were discovered to not change (or to not substantially changing) color (e.g., darkening, yellowing) during cure. Suitable accelerators may include tertiary amines and tertiary amine salts, metal carboxylates, trialkylphosphines, tetraalkylphosphonium salts, or combinations thereof. Suitable accelerators may include benzlydimethylamine (BDMA) and tris(dimethylaminomethyl)phenol, triethylene diamine (TEDA), N,N-dimethylpiperazine and 2-(dimethylaminomethyl)phenol.

In some embodiments, accelerators may be present in the curable compositions in amounts of from 0.01-5.0, 0.02-2.0, 0.02-1.0, or 0.02-1.0 parts by weight per 100 parts total weight of reactive components in the curable composition.

The curable composition may contain additional optional additives. These optional additives can be either solids or liquids, and reactive or unreactive. Among the suitable additives are fillers, including thermally conductive fillers, flame retardants (such as ATH (aluminum trihydrate) or phosphate flame retardants), nanoparticles or functionalized nanoparticles, chain extenders, toughening agents, or combinations thereof. These components are typically solids, but some of the additive components can be liquids, and these liquid components may be suitable.

Examples of non-reactive additives include fillers, flame retardants, nanoparticles, and toughening agents. Particularly suitable non-reactive additives are fillers such as metal oxides (silica, titania, magnesium oxide, and the like) and thermal conductivity enhancers such as boron nitride.

In some embodiments, additives for the curable compositions of the present disclosure may include one or more epoxy toughening agents. Such toughening agents may be useful, for example, for improving certain properties of the compositions so that they do not undergo brittle failure in a fracture. Examples of useful toughening agents, which may also be referred to as elastomeric modifiers, include polymeric compounds having both a rubbery phase and a thermoplastic phase such as graft copolymers having a polymerized diene rubbery core and a polyacrylate or polymethacrylate shell; graft copolymers having a rubbery core with a polyacrylate or polymethacrylate shell; elastomeric particles polymerized in situ in the epoxide from free-radical polymerizable monomers and a copolymeric stabilizer; elastomer molecules such as polyurethanes and thermoplastic elastomers; separate elastomer precursor molecules; combination molecules that include epoxy-resin segments and elastomeric segments; and, mixtures of such separate and combination molecules. The combination molecules may be prepared by reacting epoxy resin materials with elastomeric segments; the reaction leaving reactive functional groups, such as unreacted epoxy groups, on the reaction product. The use of tougheners in epoxy resins is described in the Advances in Chemistry Series No. 208 entitled “Rubbery-Modified Thermoset Resins”, edited by C. K. Riew and J. K. Gillham, American Chemical Society, Washington, 1984. The amount of toughening agent to be used depends in part upon the final physical characteristics of the cured resin desired.

In some embodiments, the toughening agent in the curable compositions of the present disclosure may include graft copolymers having a polymerized diene rubbery backbone or core to which is grafted a shell of an acrylic acid ester or methacrylic acid ester, monovinyl aromatic hydrocarbon, or a mixture thereof, such as those disclosed in U.S. Pat. No. 3,496,250 (Czerwinski). Rubbery backbones can comprise polymerized butadiene or a polymerized mixture of butadiene and styrene. Shells comprising polymerized methacrylic acid esters can be lower alkyl (C₁₋₄) methacrylates. Monovinyl aromatic hydrocarbons can be styrene, alpha-methylstyrene, vinyltoluene, vinylxylene, ethylvinylbenzene, isopropylstyrene, chlorostyrene, dichlorostyrene, and ethylchlorostyrene.

Further examples of useful toughening agents are acrylate core-shell graft copolymers wherein the core or backbone is a polyacrylate polymer having a glass transition temperature (T_{g}) below about 0° C., such as poly(butyl acrylate) or poly(isooctyl acrylate) to which is grafted a polymethacrylate polymer shell having a T_{g} about 25° C. such as poly(methyl methacrylate). For acrylic core/shell materials “core” will be understood to be acrylic polymer having T_{g}<0° C. and “shell” will be understood to be an acrylic polymer having T_{g}>25° C. Some core/shell toughening agents (e.g., including acrylic core/shell materials and methacrylate-butadiene-styrene (MBS) copolymers wherein the core is crosslinked styrene/butadiene rubber and the shell is polymethylacrylate) are commercially available, for example, from Dow Chemical Company under the trade designation “PARALOID”.

Another useful core-shell rubber is described in U.S. Pat. Appl. Publ. No. 2007/0027233 (Yamaguchi et al.). Core-shell rubber particles as described in this document include a cross-linked rubber core, in most cases being a cross-linked copolymer of butadiene, and a shell which is preferably a copolymer of styrene, methyl methacrylate, glycidyl methacrylate and optionally acrylonitrile. Specific examples are Kane Ace M731, M732, M511, and M300 commercially available from Kaneka.

In some embodiments, the toughening agent may include an acrylic core/shell polymer; a styrene-butadiene/methacrylate core/shell polymer; a polyether polymer, a carboxyl- or amino-terminated acrylonitrile/butadiene; a carboxylated butadiene, a polyurethane, or a combination thereof.

In some embodiments, toughening agents may be present in the curable composition in an amount between 0.1 and 10 wt. %, 0.1 and 5 wt. %, 0.5 and 5 wt. %, 1 and 5 wt. %, or 1 and 3 wt. %, based on the total weight of the curable composition.

In some embodiments, upon curing, the curable compositions of the present disclosure may exhibit thermal, mechanical, and rheological properties that render the compositions particularly useful as adhesives or coatings for cosmetic applications that require strong adhesion to substrates over time as well as strong adhesion to substrates upon sudden impact (i.e., strong drop performance). In some embodiments, in addition to having strong adhesion, durability, drop performance, the curable compositions of the present disclosure may exhibit color stability in the presence of heat, UV light, and household chemicals, as well as when exposed to chemical anodization or dye infusion processes. In this regard, in some embodiments, upon exposure to an acid bath in accordance with the Acid Bath Test Method set forth in the Examples of the present disclosure, the cured compositions of the present disclosure may exhibit a ΔE 94 color change of less than 1, less than 0.8, or less than 0.5. In some embodiments, upon exposure to an ultraviolet light in accordance with the UV Exposure Test Method set forth in the Examples of the present disclosure, the cured compositions of the present disclosure may exhibit a ΔE 94 color change of less than 3, less than 2, or less than 1.

In some embodiments, the cured compositions exhibit performance properties requisite of an adhesive suitable for use in electronic devices. In this regard, in some embodiments, the cured compositions may have an overlap shear value on an etched aluminum substrate of at least 25 MPa, at least 30 MPa, or at least 35 MPa. For purposes of the present disclosure, overlap shear values are determined in accordance with ASTM D-1002-72. Further, the cured compositions may have a notched izod toughness value of at least 20 J/m, at least 30 J/m, or at least 40 J/m. For purposes of the present disclosure, notched izod toughness values are determined in accordance with ASTM D-256.

In some embodiments, the cured compositions may have a tensile elongation of at least 10% and a glass transition temperature of at least 80 degrees Celsius.

In some embodiments, the curing time of the curable composition is less than 5 hours, less than 3 hours, or less than 1 hour at room temperature.

In some embodiments, the curable compositions of the present disclosure may be provided (e.g., packaged) as a two-part composition, in which a first part includes the above-described non-aromatic epoxy resin and a second part includes the above described aliphatic or cycloaliphatic curing agent. The other components of the curable compositions (e.g., colorants, accelerators, fillers, dispersants, and the like), can be included in one or both of the first and second parts. The present disclosure further provides a dispenser comprising a first chamber and a second chamber. The first chamber comprises the first part, and the second chamber comprises the second part. Applying the curable composition can be carried out, for example, by dispensing the curable composition from a dispenser comprising a first chamber, a second chamber, and a mixing tip, wherein the first chamber comprises the first part, wherein the second chamber comprises the second part, and wherein the first and second chambers are coupled to the mixing tip to allow the first part and the second part to flow through the mixing tip.

Alternatively, in some embodiments, the curable compositions can be formulated as one part formulations.

The present disclosure is further directed to methods of making the above-described curable compositions. In some embodiments, the curable compositions of the present disclosure may be prepared by, first, mixing the components of the first part (non-aromatic epoxy resin, including any additives) and, separately, mixing the components of the second part (aliphatic or cycloaliphatic curing agent, including any additives). The components of both the first and second parts may be mixed using any conventional mixing technique, including by use of a speed mixer. Next, the first and second parts may be mixed together using any conventional mixing technique to form the curable composition.

Also disclosed herein are articles prepared from the curable compositions described above.

In some embodiments, the articles of the present disclosure may be fabricated by forming the curable compositions (before, after, or during cure) into a desirable or predetermined shape. Shaping of the curable compositions (or cured compositions) may be carried out using machining, micromachining, microreplication, molding, extruding injection molding, ceramic pressing, or the like. In this manner, articles of any size or shape may be formed using the curable compositions of the present disclosure. For example, in some embodiments, the articles of the present disclosure may include user visible, or cosmetic, components of an electronic device (e.g., a case or housing for a mobile phone, tablet, watch, headphone, or laptop).

In further embodiments, the curable compositions may be coated onto a substrate and permitted to cure. The articles may include a substrate comprising a first major surface and a second major surface, and a coating on at least a portion of the second major surface of the substrate, where the coating comprises a cured layer of a curable composition.

The coatings can be coated on a wide range of substrates. Examples of suitable substrates include metal substrates, ceramic substrates, glass substrates, or polymeric substrates. The substrates can be in a variety of shapes such as plates or tubes, and may have smooth or irregular surfaces and may be hollow or solid.

The curable composition can be applied to a substrate to form a curable layer using a variety of techniques, including dip coating, forward and reverse roll coating, wire wound rod coating, and die coating. Die coaters include knife coaters, slot coaters, slide coaters, fluid bearing coaters, slide curtain coaters, and drop die curtain coaters. Upon coating, the curable composition is permitted to cure to form a cured coating.

The thickness of the coating varies depending upon the desired use for the coating. In some embodiments, the coatings may range from 25 micrometers (1 mil) to 1 millimeter in thickness. The curable compositions may be coated onto substrates at useful thicknesses ranging from 5 microns to 10000 microns, 25 micrometers to 10000 micrometers, 100 micrometers to 5000 micrometers, or 250 micrometers to 1000 micrometers.

In some embodiments, the curable composition may function as a structural adhesive, i.e. the curable composition is capable of bonding a first substrate to a second substrate, after curing. In some embodiments, the present disclosure provides an article comprising a first substrate, a second substrate, and a cured composition disposed between and adhering the first substrate to the second substrate, wherein the cured composition is the reaction product of the curable composition according to any one of the curable compositions of the present disclosure. In some embodiments, the first and/or second substrate may be at least one of a metal, a ceramic, and a polymer.

The curable compositions may be coated onto substrates at useful thicknesses ranging from 5 microns to 10000 microns, 25 micrometers to 10000 micrometers, 100 micrometers to 5000 micrometers, or 250 micrometers to 1000 micrometers. Useful substrates can be of any nature and composition, and can be inorganic or organic. Representative examples of useful substrates include ceramics, siliceous substrates including glass, metal (e.g., aluminum or steel), natural and man-made stone, woven and nonwoven articles, polymeric materials, including thermoplastic and thermosets, (such as polymethyl (meth)acrylate, polycarbonate, polystyrene, styrene copolymers, such as styrene acrylonitrile copolymers, polyesters, polyethylene terephthalate), silicones, paints (such as those based on acrylic resins), powder coatings (such as polyurethane or hybrid powder coatings), and wood; and composites of the foregoing materials.

In some embodiments, the curable compositions of the present disclosure may be used as a cosmetic inlay for an electronic device or component of an electronic device. Generally, a cosmetic inlay refers to a component that is positioned within a gap or hole in another material, and that is positioned, sized, and shaped such that it fills (or substantially fills) the gap or hole and is flush (o rsubstantially flush) with the material adjacent the component/inlay. In some embodiments, the curable compositions may be used a cosmetic inlay for the casing or housing or an electronic device (mobile phone, tablet, or laptop). The casing or housing may be formed of metal (e.g. aluminum).

### Examples

Unless otherwise noted, all parts, percentages, ratios, etc. in the Examples and the rest of the specification are by weight.

| Abbreviation | Description |
|---|---|
| YX8000 | Phenol, 4,4′-(1-methylethylidene)bis-, polymer with 2- |
| | (chloromethyl)oxirane, hydrogenated, obtained from |
| | Mitsubishi Chemicals, Tokyo Japan. |
| BDGE | 4,4′-Isopropylidenediphenol-Epichlorohydrin Copolymer. |
| | obtained from Hexion Inc., Columbus Ohio. |
| MXDA | 1,3-bisaminomethylbenzene, obtained from Mitsubishi Gas |
| | Chemical Co., Tokyo, Japan. |
| TTD | 4,7,10-trioxatridecane-1,13-diamine, obtained from BASF |
| | SE, Ludwigshafen, Germany. |
| YX8034 | Phenol, 4,4′-(1-methylethylidene)bis-, polymer with 2- |
| | (chloromethyl)oxirane, hydrogenated, obtained from |
| | Mitsubishi Chemicals, Tokyo, Japan. |
| MHHPA | 4-methyl-1,2-cyclohexanedicarboxylic anhydride, obtained |
| | under the trade designation “LINDRIDE 52D” from |
| | Lindau Chemicals, Columbia, South Carolina. |
| DDSA | Dodecenylsuccinic anhydride obtained from Sigma |
| | Aldrich, St. Louis Missouri. |
| 88000 | Solsperse 88000 polymeric dispersant obtained from |
| | Lubrizol Corp. Wickliffe, Oho. |
| CB | Carbon black pigment obtained under the trade designation |
| | “MOGUL E” from Cabot Inc, Chicago, Illinois. |
| TiO2 | Titanium dioxide pigment, obtained under the |
| | trade designation “KRONOS |
| | 2160” from Kronos Worldwide, Inc., Dallas, Texas. |
| SiO2 | Hydrophobic fumed silica, obtained under the trade |
| | designation “CAB-O-SIL TS720”, from Cabot Inc. |
| BDMA | Benzyl-N,N-dimethyl amine obtained from |
| | Sigma Aldrich , St. Louis MO. |

### Test Methods and Preparation and General Procedures

### Color Change Test Method

The color change of the plaques was measured as follows. Initial color was measured for each plaque using a Konica CM3700A spectrophotometer (available from Konica Minolta Sensing Americas, Inc. Ramsey, New Jersey), in reflectance specular component included (SCI) mode with a 10 degree observer angle. After a plaque was exposed to the Anodization Bath Simulation Process, the color was measured again. The difference in color before and after the acid bath exposure was calculated using the ΔE 94 calculation as designated by the International Commission on Illumination (CIE) with an 1:C ratio of 2:1 under the illuminants F02 (cool white fluorescent). A ΔE 94 color change of less than 1 is generally regarded as undetectable to the human eye.

### Preparation of Acid Baths to Simulate Anodization Process

Suitable anodization processes for electronic devices made with aluminum are described in US2013/0270120 A1. The process steps having the greatest impact on adhesive color are de-smut and chemical polish. A de-smut bath was made using 30% nitric acid. A chemical polish bath was made by mixing 129 g of concentrated sulfuric acid (98%) with 441 g of 85% phosphoric acid.

### Anodization Bath Simulation Process

The Example and Comparative Example plaques were individually immersed in the de-smut bath for 30 seconds at 25° C.; this was immediately followed by a 30 second rinse in deionized water. Next, the plaques were immersed for 60 seconds in the chemical polish bath which had been pre-heated to 80° C. This was followed by rinsing in deionized water for 60 seconds. The plaques were then allowed to dry at ambient conditions before final color measurement. The color change data after the anodization simulation process are presented in Tables 2-5.

### UV Stability Test

The unpigmented plaques were tested for UV stability according to ASTM D4459. The duration was 100 hrs. The color change results, based on the Color Change Test Method, are presented in Table 6. For UV stability, a ΔE 94 value less than 3 is considered acceptable.

### Preparation of Plaques Used in the Examples and Comparative Examples

Materials, as shown in Table 1, for each Example (Ex) and Comparative Example (CE) were combined and then mixed under vacuum using a speed mixer, forming a curable composition. Each composition was then cast between a release coated polyester film to give a plaque that was 2 mm in thickness. The plaques were cured for 2 hours at 120° C. in an oven.

TABLE 1
Curable Composition Formulations

| Example | YX8000 | BDGE | MXDA | TTD | YX8034 | MHHPA | DDSA | 88000 | CB | TiO2 | SiO2 | BDMA |
|---|---|---|---|---|---|---|---|---|---|---|---|---|
| CE1 | | 33.32 | 6.68 | | | | | | | | 0.86 | |
| CE2 | | 33.32 | 6.68 | | | | | .03 | .006 | 2 | 0.86 | |
| CE3 | | 33.32 | 6.68 | | | | | .03 | | 2.8 | 0.86 | |
| CE4 | | 33.32 | 6.68 | | | | | | .4 | .4 | 0.86 | |
| CE5 | | 30.22 | | 9.78 | | | | | | | .86 | |
| CE6 | | 30.22 | | 9.78 | | | | .03 | .006 | 2 | .86 | |
| CE7 | | 30.22 | | 9.78 | | | | .03 | | 2.8 | .86 | |
| CE8 | | 30.22 | | 9.78 | | | | | .4 | .4 | .86 | |
| CE9 | 30.89 | | | 9.12 | | | | | | | 0.86 | |
| Ex1 | | | | | 23.56 | 11.46 | 2.13 | | | | 1.35 | 0.4 |
| Ex2 | | | | | 23.56 | 11.46 | 2.13 | .03 | .006 | 2 | 1.35 | 0.4 |
| Ex3 | | | | | 23.56 | 11.46 | 2.13 | .03 | | 2.8 | 1.35 | 0.4 |
| Ex4 | | | | | 23.56 | 11.46 | 2.13 | | .4 | .4 | 1.35 | 0.4 |
| Ex5 | 30.89 | | | 9.12 | | | | .03 | .006 | 2 | 0.86 | |
| Ex6 | 30.89 | | | 9.12 | | | | .03 | | 2.8 | 0.86 | |
| Ex7 | 30.89 | | | 9.12 | | | | | .4 | .4 | 0.86 | |

TABLE 2
Unpigmented Adhesives

| Example | ΔE 94 Color Change |
|---|---|
| CE1 | 36.11 |
| CE5 | 19.7 |
| CE9 | 15.21 |
| Ex1 | 0.11 |

TABLE 3
Light Grey Adhesives

| Example | ΔE 94 Color Change |
|---|---|
| CE2 | 34.11 |
| CE6 | 31.09 |
| Ex2 | 0.45 |
| Ex5 | 0.6 |

TABLE 4
White Adhesives

| Example | ΔE 94 Color Change |
|---|---|
| CE3 | 47.33 |
| CE7 | 45.55 |
| Ex3 | 0.59 |
| Ex6 | 0.6 |

TABLE 5
Black Adhesives

| Example | ΔE 94 Color Change |
|---|---|
| CE4 | 2.99 |
| CE8 | 2.15 |
| Ex4 | 0.1 |
| Ex7 | 2.62 |

TABLE 6
ΔE 94 Results (After UV Exposure)

| Example | ΔE 94 Color Change |
|---|---|
| CE1 | 35.02 |
| CE5 | 8.23 |
| CE9 | 0.58 |
| Ex1 | 2.12 |

1. A curable composition comprising:
a non-aromatic epoxy resin;
a non-aromatic curing agent; and
a colorant;
wherein a cured composition that is the reaction product of the curable composition exhibits an overlap shear value on etched aluminum of at least 30 MPa.

2. The curable composition of claim 1, wherein the cured composition has a notched izod toughness value of at least 30 J/m.

3. The curable composition of claim 1, further comprising an accelerator comprising a tertiary amine, tertiary amine salt, metal carboxylate, trialkylphosphine, or tetraalkylphosphonium salt.

4. The curable composition of claim 1, wherein the curing agent comprises an anhydride-based curing agent

5. The curable composition of claim 1, wherein the curable composition comprises 10-45 parts by weight of anhydride-based curing agent per 100 parts total weight of reactive components.

6. The curable composition of claim 1, wherein the anhydride-based curing agent comprises an aliphatic or cycloaliphatic moiety.

7. The curable composition of claim 1, wherein the curable composition comprises 50-95 parts by weight of non-aromatic epoxy resin per 100 parts total weight of reactive components.

8. The curable composition of claim 1, wherein the colorant is present in the curable compositions in an amount of between 0.1 and 10 wt. %, based on the total weight of the reactive components.

9. The curable composition of claim 1, further comprising a toughening agent.

10. A curable composition comprising:
a non-aromatic epoxy resin; and
a non-aromatic curing agent; and
wherein a cured composition that is the reaction product of the curable composition, upon exposure to an acid bath in accordance with the Acid Bath Test Method, exhibits a ΔE 94 color change of less than 1.

11. The curable composition of claim 10, further comprising a colorant.

12. The curable composition of claim 10, further comprising an accelerator comprising a tertiary amine, tertiary amine salt, metal carboxylate, trialkylphosphine, or tetraalkylphosphonium salt.

13. The curable composition of claim 10, wherein the curing agent comprises an anhydride-based curing agent.

14. The curable composition of claim 13, wherein the anhydride-based curing agent comprises an aliphatic or cycloaliphatic moiety.

15. The curable composition of claim 10, wherein the curable composition comprises 10-45 parts by weight of anhydride-based curing agent per 100 parts total weight of reactive components.

16. The curable composition of claim 10, wherein the curable composition comprises 50-95 parts by weight of non-aromatic aromatic epoxy resin per 100 parts total weight of reactive components.

17. The curable composition of claim 10, wherein the colorant is present in the curable compositions in an amount of between 0.1 and 10 wt. %, based on the total weight of the reactive components.

18. The curable composition of claim 10, further comprising a toughening agent.

19. An article comprising a cured composition, wherein the cured composition is the reaction product of the curable composition according to claim 1.

20. An article comprising a first substrate, a second substrate and a cured composition disposed between and adhering the first substrate to the second substrate, wherein the cured composition is the reaction product of the curable composition according to claim 1.
